(19) United States
(12) Patent Application Publication
(10) Pub. No.: US 2011/0013353 A1
(43) Pub. Date: Jan. 20, 2011

(54) MULTI-CHIP PACKAGE STRUCTURE SUITABLE FOR MULTI-PROCESSOR SYSTEM HAVING MEMORY LINK ARCHITECTURE

(75) Inventors: Jin-Hyoung Kwon, Seongnam-si (KR); Bo-Il Shim, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/717,027

(22) Filed: Mar. 3, 2010

(30) Foreign Application Priority Data
Jul. 14, 2009 (KR) 10-2009-0064132

(51) Int. Cl. G06F 1/16

(52) U.S. Cl. 361/679.31

(57) ABSTRACT

A multi-chip package structure can include a first package that includes a first circuit board that includes a lower surface including a first circuit pattern thereon and an upper surface, that is opposite the lower surface, and includes an upper pad layer thereon. The multi-chip package structure can further include at least one processor chip that is mounted on the lower surface of the first circuit board. A second package can be mounted on the first package and can include a second circuit board including an upper surface that includes a second circuit pattern thereon and a lower surface, which is opposite the upper surface, which can includes a lower pad layer thereon that is electrically connected to the upper pad layer of the first circuit board. At least one memory chip can be laminated and molded on the upper surface of the second package.

### CROSS-REFERENCE TO RELATED APPLICATION

This application claims priority under 35 U.S.C. §119 from Korean Patent Application No. 10-2009-0064132, filed on Jul. 14, 2009, the contents of which are hereby incorporated by reference in their entirety for all purposes as if fully set forth herein.

### BACKGROUND

The present invention relates to a package structure of semiconductor chips, and more particularly, to a multi-chip package structure suitable for a multi-processor system.

In recent years, multi-processor systems including a plurality of processors in one system have been used for portable electronic apparatuses, such as a portable multi-media player (PMP), a mobile phone, a smart phone, a GPS navigation apparatus, a digital camera, a digital video camera, and a PDA, in order to improve the functions, increase an operation speed, and smoothly perform operations. For example, the mobile phone may have music, game, camera, payment, and moving picture player functions in addition to a basic call function, according to the user's demand for convergence.

In the multi-processor system, the operation or function of a semiconductor memory used to store processing data in a multi-processor system may be changed in various ways. For example, the simultaneous input or output of data through a plurality of access ports may be provided. A multi-port semiconductor memory device, such as OneDRAM™ manufactured by Samsung Electronics, Co., Ltd., is a fusion memory chip capable of increasing a data process speed between the communication processor and the media processor in the mobile device. In general, when two processors are provided, two memories can be used. However, since the OneDRAM™ solution can route data between the processors using a single chip, it is possible to avoid the use of two memories. In addition, when a dual port approach is used, the OneDRAM™ can reduce data transmission time between the processors.

The multi-processor system using the multi-port semiconductor memory device can form a memory link architecture in which a multi-port semiconductor memory device and a flash memory are linked to an arbitrary processor.

When the multi-processor system forming the memory link architecture is provided in a portable electronic apparatus, it can be mounted on a main circuit board in the form of a package. In order to reduce the size and height of an integrated package, the package connection structure between a memory package including memory chips and a processor package including processor chips can be changed.

### SUMMARY

Embodiments of the invention also provide a multi-chip package structure suitable for a multi-processor system having a memory link architecture and a method of manufacturing a package.

According to some embodiments of the invention, a multi-chip package structure can include a first package that includes a first circuit board that includes a lower surface including a first circuit pattern thereon and an upper surface, that is opposite the lower surface, and includes an upper pad layer thereon. The multi-chip package structure can further include at least one processor chip that is mounted on the lower surface of the first circuit board. A second package can be mounted on the first package and can include a second circuit board including an upper surface that includes a second circuit pattern thereon and a lower surface, which is opposite the upper surface, which can includes a lower pad layer thereon that is electrically connected to the upper pad layer of the first circuit board. At least one memory chip can be laminated and molded on the upper surface of the second package.

The upper pad layer and the lower pad layer may be connected to each other by land grid array pads. The processor chips may be mounted on the lower surface of the first circuit board so as to be surrounded by contact pads.

The processor chips may include a MODEM chip and an application chip. The at least one memory chip may include a OneNAND™, a OneDRAM™, and a multi-bank DRAM each having a laminated structure.

According to further embodiments of the invention, a multi-chip package structure includes a first package and a second package. The first package includes first circuit board having a lower surface on which predetermined circuit patterns are separately formed and an upper surface on which an upper pad layer is formed, processor chips mounted on the lower surface of the first circuit board to be connected to the predetermined circuit patterns, and routing lines electrically connecting the processor chips. The second package includes a second circuit board having an upper surface on which a predetermined circuit pattern is formed and a lower surface on which a lower pad layer is formed so as to be electrically connected to the upper pad layer of the first package, and at least one memory chip laminated and molded on the upper surface of the second package.

The upper pad layer and the lower pad layer may be connected to each other by land grid array contact. The processor chips may be mounted on the lower surface of the first circuit board such that each of the processor chips is surrounded by contact pads.

The routing lines may be formed in or on the second circuit board. The at least one memory chip may include a NAND flash memory, a multi-port semiconductor memory, and a multi-bank DRAM each having a laminated structure.

The multi-processor system including the multi-chip package may implement at least one of the functions of a mobile phone, a PMP, a PSP, a PDA, and a mobile phone for a vehicle.

According to the above-mentioned embodiments of the invention, since the processor package and the memory package are directly connected to each other in a land grid array type, the height and size of the package are reduced. This package connection structure can improve product reliability and productivity.

### BRIEF DESCRIPTION OF THE DRAWINGS

FIG. 1 is a block diagram illustrating the connection of chips in a multi-chip package according to an embodiment of the invention;

FIGS. 2 and 3 are diagrams illustrating examples of the multi-chip package structure of the chip connection block shown in FIG. 1;

FIG. 4 is a diagram illustrating the structure of a multi-chip package according to an embodiment of the invention;

FIG. 5 is a detailed cross-sectional view of FIG. 4;

FIG. 6 is a plan view illustrating a lower surface of a second circuit board shown in FIG. 5;

FIG. 7 is a plan view illustrating a lower surface of the first circuit board shown in FIG. 5;

FIG. 8 is a diagram illustrating the structure of a multi-chip package according to another embodiment of the invention;

FIG. 9 is a detailed cross-sectional view of FIG. 8;

FIG. 10 is a plan view illustrating a lower surface of a second circuit board shown in FIG. 9; and

FIG. 11 is a plan view illustrating a lower surface of the first circuit board shown in FIG. 9.

### DETAILED DESCRIPTION OF THE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Hereinafter, package connection structures according to embodiments of the invention which integrally connect processor packages each having processor chips and a memory package having laminated memory chips through land grid array pads will be described with reference to the accompanying drawings.

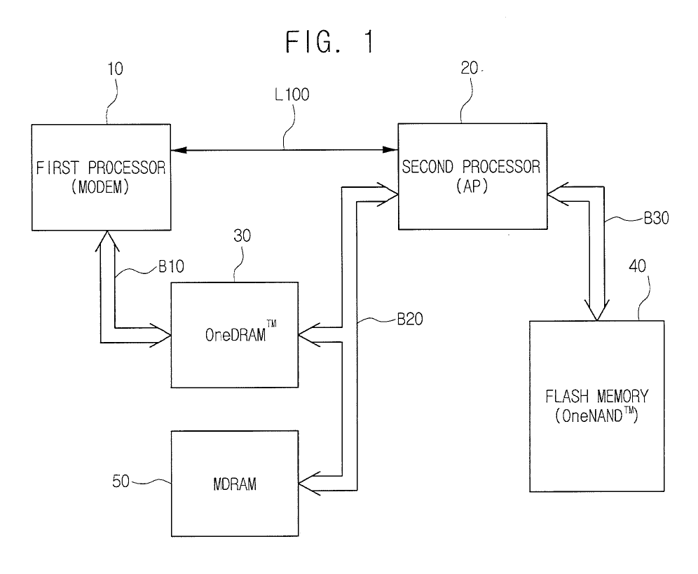

FIG. 1 is a block diagram illustrating the chip connection of a multi-chip package according to an embodiment of the invention. Referring to FIG. 1, a multi-processor system forming, for example, a mobile device includes a first processor 10 serving as a MODEM processor, a second processor 20 serving as an application processor that performs mobile communication and additional functions, a OneDRAM™ 30 serving as a multi-port semiconductor memory device, a multi-bank DRAM 50 having multiple banks, and a flash memory 40 which is a OneNAND™ memory.

In FIG. 1, the first processor 10 connected to a communication antenna (not shown) may basically have the function of a MODEM processor that performs a predetermined task, for example, an operation of modulating and demodulating communication signals. The second processor 20 connected to the first processor 10 through a serial communication line L100 may serve as a media processor that processes communication data or performs user convenience functions, such as entertainments and games.

The first processor 10 is connected to the OneDRAM™ 30 through a system bus B10, and the second processor 20 is connected to the OneDRAM™ 30 through a system bus B20. That is, the first and second processors 10 and 20 share the OneDRAM™ 30. Therefore, it is not necessary to use two DRAMs. As a result, the cost of constructing a system and the size of the system are reduced. The multi-bank DRAM 50 is connected to the second processor 20 through the system bus B20 and provides the function of a multi-bank memory.

The flash memory 40 is connected to the second processor 20 through a system bus B30, but the first processor 10 indirectly accesses the flash memory 40 through the OneDRAM™ 30 and the second processor 20. On the other hand, the second processor 20 directly accesses the flash memory 40.

The flash memory 40 may be a NOR flash memory in which a cell array has a NOR structure or a NAND flash memory in which a cell array has a NAND structure. Each of the NOR flash memory and the NAND flash memory is a non-volatile memory including an array of memory cells each including a MOS transistor with a floating gate. The NOR flash memory or the NAND flash memory is provided in order to store data that should not be removed even though power is turned off, such as boot codes of a mobile device, programs, communication data, or storage data. Therefore, since one flash memory 40 is provided so as to correspond to two processors in the system, the cost of constructing the system is reduced, and the size of the system is reduced.

The OneDRAM™ 30 serves as a main memory for processing the data of the first and second processors 10 and 20. In addition, the OneDRAM™ 30 includes a plurality of ports and a plurality of memory banks in order to allow a multi-port access. The OneDRAM™ 30 including the plurality of ports and the plurality of memory banks is different from a general DRAM having a single port.

In FIG. 1, the first and second processors 10 and 20 access the memory banks of the OneDRAM™ 30 through different access paths.

When the OneDRAM™ 30 has a memory cell array including four memory areas, a first bank, which is a memory area, may be exclusively accessed by the first processor 10, and third and fourth banks may be exclusively accessed by the second processor 20. A second bank which is allocated as a shared memory area may be accessed by both the first and second processors 10 and 20 through different ports.

When the first processor 10 accesses the second bank through a first port, a path control unit of the OneDRAM™ 30 connects the second bank to the system bus B10. While the first processor 10 is accessing the second bank, the second processor 20 may access the third bank or the fourth bank, which is a dedicated memory, through a second port. After the access of the first processor 10 to the second bank is completed, the second processor 20 may access the second bank, which is a shared memory area.

An internal register that performs interfacing between the first and second processors 10 and 20 is provided in the OneDRAM™ 30. The internal register is a data storage area that is provided separately from the memory cell array area. The internal register may be accessed by both the first and second processors 10 and 20 and may be composed of a latch circuit such as a flip-flop. The internal register is composed of memory cells (for example, SRAM cells) of a latch type different from that of the memory cells of the DRAM. Therefore, the internal register does not require a refresh operation.

The OneDRAM™ 30, the second processor 20 capable of being composed of an ASIC, and the flash memory 40 may form a memory link architecture (MLA).

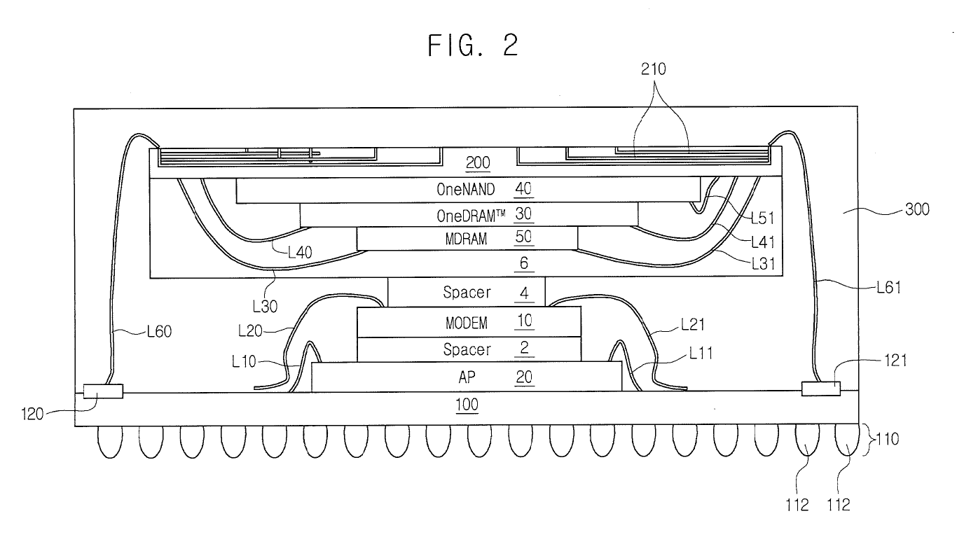

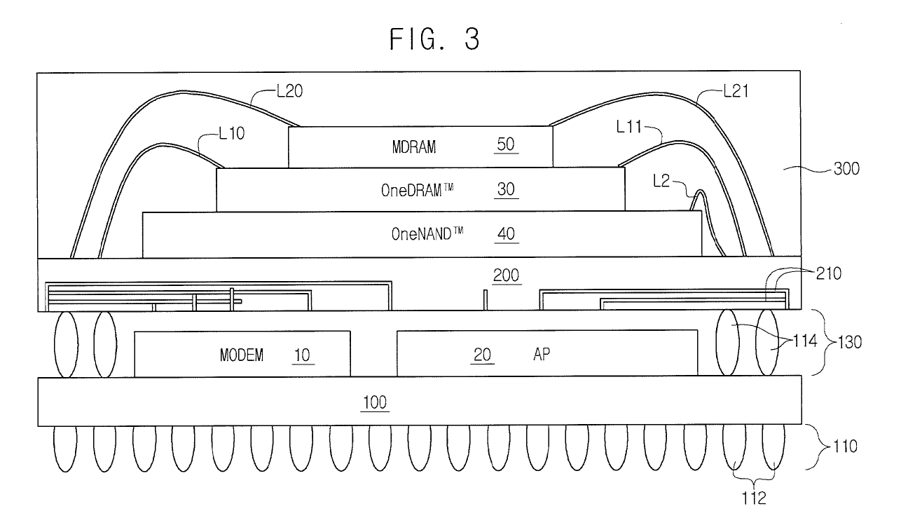

When the multi-processor system shown in FIG. 1 is constructed, it is preferable that a memory package and a processor package form a multi-chip package in order to improve the mounting efficiency of parts. Therefore, the chip connection block shown in FIG. 1 may be a multi-chip package type shown in FIG. 2 or FIG. 3.

FIGS. 2 and 3 are diagrams illustrating examples of the multi-chip package structure of the chip connection block shown in FIG. 1.

First, referring to FIG. 2, the multi-chip package 300 is divided into a processor package formed on a first circuit board 100 and a memory package formed on a second circuit board 200.

In FIG. 2, in the processor package, an AP (application processor) 20, a separation spacer 2, a MODEM 10, and a spacer 4 are sequentially formed on the first circuit board 100. In the memory package, a OneNAND™ 40, a OneDRAM™ 30, a multi-bank DRAM 50, and a molding layer 6 are sequentially formed on the second circuit board 200 in a direction facing the first circuit board 100. Wiring lines L10, L11, L20, and L21 shown in FIG. 2 are for electrically connecting the processors to the first circuit board 100. Wiring lines L30, L31, L40, L41, and L51 are for electrically connecting the memory chips to the second circuit board 200. Wiring lines 210 formed on the second circuit board 200 are connected to conductive pads 120 and 121 formed on the first circuit board 100 through connection lines L60 and L61.

In this way, the upper package and the lower package are integrated into one multi-chip package and a connection layer 110 having connection bumps 112 provided thereon is formed on the lower surface of the first circuit board 100 for electrical connection to the main circuit board.

However, since a package-in-package (PIP) structure shown in FIG. 2 uses the spacers 2 and 4 for separating the chips, the height of the package is increased. In addition, the routing of the printed circuit board may be complicated. Further, it may be difficult to treat the manufacturing process between manufacturing companies.

FIG. 3 is a diagram illustrating an example of a package-on-package (POP) structure which is different from the PIP structure shown in FIG. 2.

In the processor package shown in FIG. 3, the MODEM 10 and the AP (application processor) 20 are formed on the first circuit board 100 so as to be separated from each other in a plan view. In the memory package, the OneNAND™ 40, the OneDRAM™ 30, and the multi-bank DRAM are sequentially formed on the second circuit board 200. Similarly, in FIG. 3, wiring lines L2, L10, L11, L20, and L21 are for electrically connecting the memory chips to the second circuit board 200. The wiring lines 210 formed on the second circuit board 200 are electrically connected to the first circuit board 100 through connection bumps 114 formed in a connecting portion 130.

In this way, the upper package and the lower package are integrated into one multi-chip package, and the connection layer 110 having the connection bumps 112 is formed on the lower surface of the first circuit board 100 for electrical connection to the main circuit board.

However, in the POP structure shown in FIG. 3, since the connection bumps 114 are used, the height of the package may be large and the circuit board may be more likely to be curved. Further, the routing of the printed circuit board may be complicated, and it is may be more difficult to treat the manufacturing process between manufacturing companies.

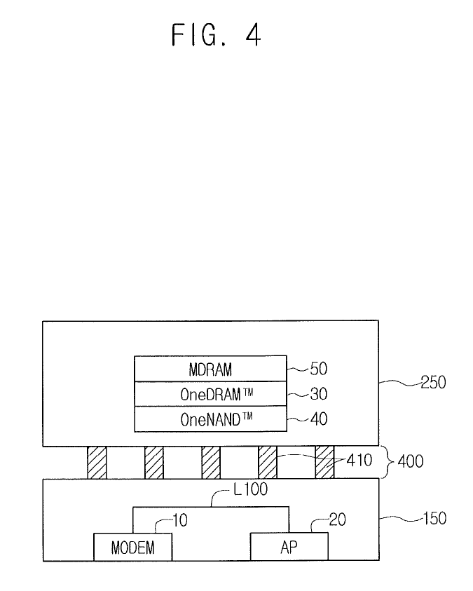

Next, a multi-chip package according to an embodiment that is improved from those shown in FIGS. 2 and 3 will be described with reference to FIG. 4.

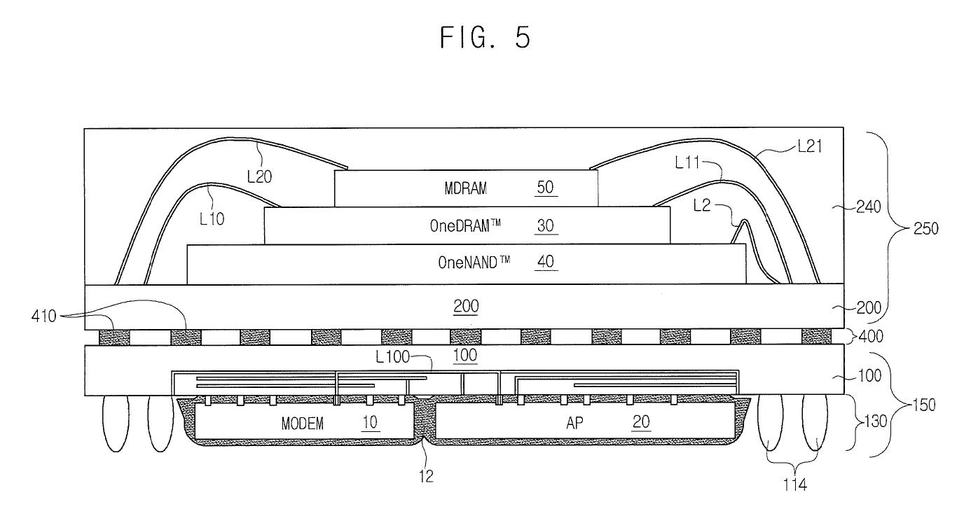

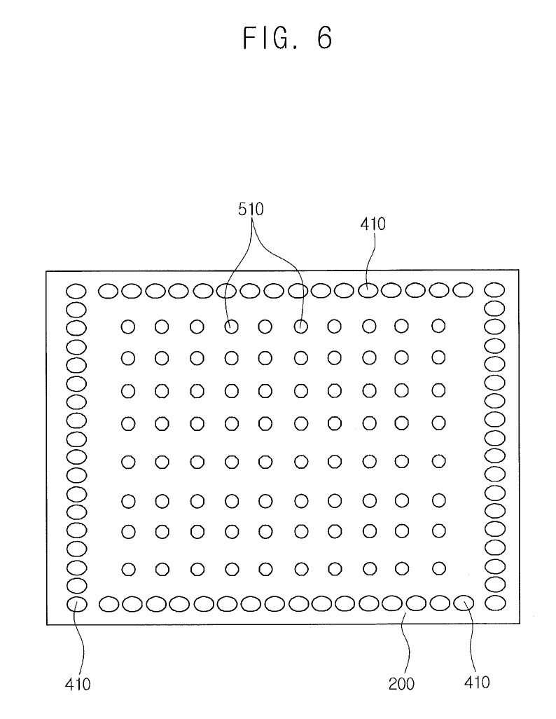

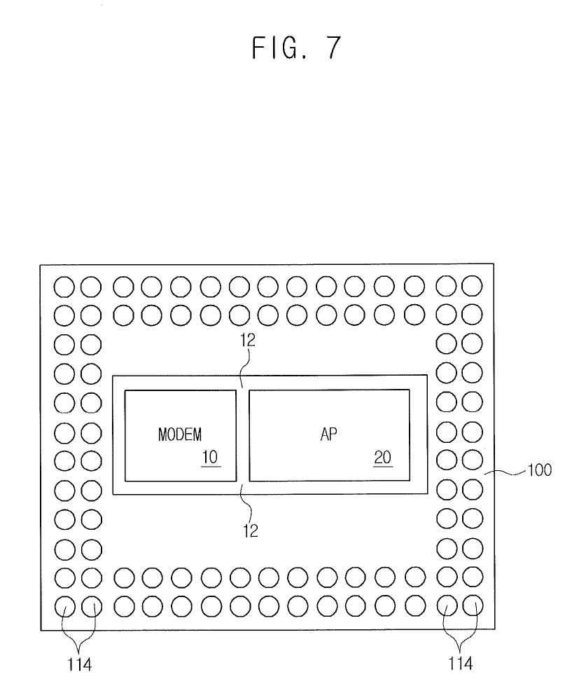

FIG. 4 is a diagram illustrating the structure of a multi-chip package according to an embodiment of the invention, and FIG. 5 is a detailed cross-sectional view of FIG. 4. FIG. 6 is a plan view illustrating a lower surface of a second circuit board shown in FIG. 5, and FIG. 7 is a plan view illustrating a lower surface of the first circuit board shown in FIG. 5.

Referring to FIG. 4, the multi-chip package according to the embodiment of the invention includes a first package 150 and a second package 250.

The first package 150 includes a first circuit board 100 shown in FIG. 5. A predetermined circuit pattern is formed on the lower surface of the first circuit board 100 on which the processor chips 10 and 20 will be mounted. An upper pad layer is formed on the upper surface of the first circuit board 100.

The second package 250 includes a second circuit board 200 shown in FIG. 5. A plurality of memory chips 40, 30, and 50 are formed on the upper surface of the second circuit board 200 having a predetermined circuit pattern provided thereon and is then molded in the same shape as that shown in FIG. 3. A lower pad layer that is electrically connected to the upper pad layer of the first circuit board 100 is formed on the lower surface of the second circuit board 200. In FIG. 4, it is noted that the upper pad layer of the first circuit board 100 and the lower pad layer of the second circuit board 200 forming a pad layer 400 are denoted by one reference numeral. As shown in the cross-sectional view of FIG. 5, the pad layer 400 may include land grid array pads 410 that connect the upper pad layer and the lower pad layer. As shown in FIG. 7, the processor chips 10 and 20 may be mounted to the lower surface of the first circuit board 100 so as to be surrounded by contact pads 114. In FIG. 7, reference numeral 12 indicates an insulating molding portion. In FIG. 6, a plurality of grid array pads 410 is arranged in a rectangular shape. In FIG. 6, reference numeral 510 indicates test pads. The test pads may be removed, if necessary.

In the structure according to the first embodiment shown in FIGS. 4 to 7, the processor packages each including processor chips and the memory package including laminated memory chips are integrally connected to each other through the land grid array pads 410. As shown in FIG. 5, the processor chips are electrically connected to each other by routing lines L100 of the first circuit board 100.

In the POP structure according to the first embodiment, since the upper and lower packages are directly connected to each other by land grid array pads, the height of the package can be reduced, and it is possible to reduce the size of the package. Therefore, in the above-mentioned structure, the PCB may be less likely to be curved.

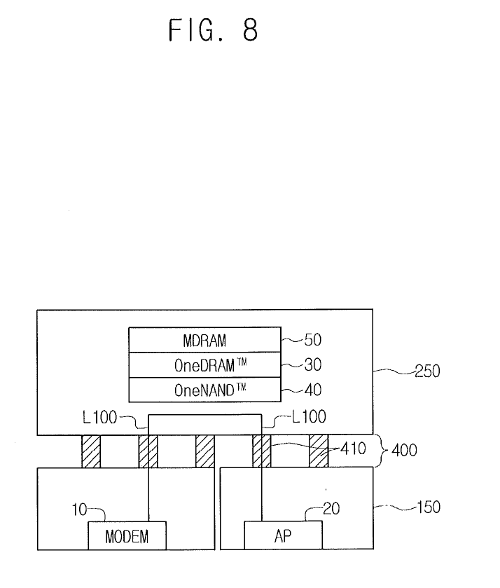

Next, a multi-chip package according to another embodiment which has a scheme different from that shown in FIG. 4 will be described with reference to FIG. 8.

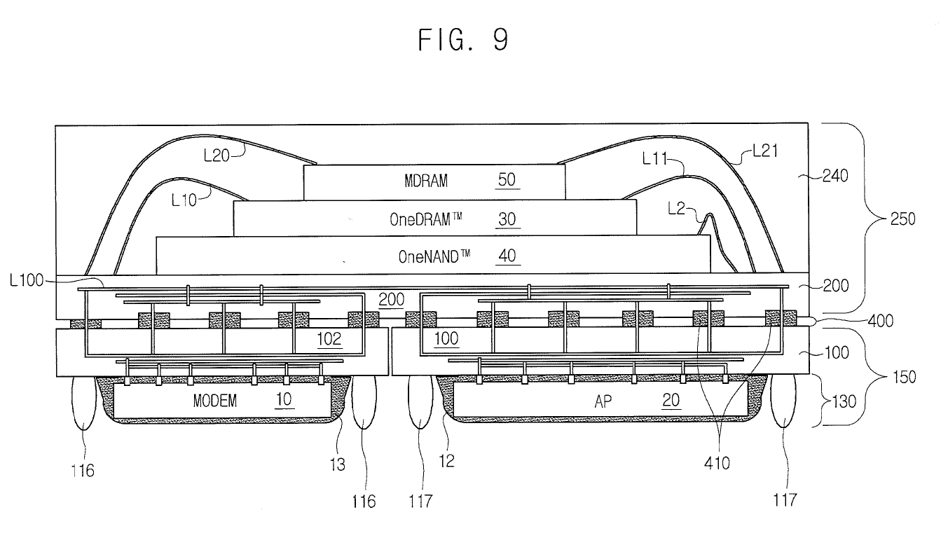

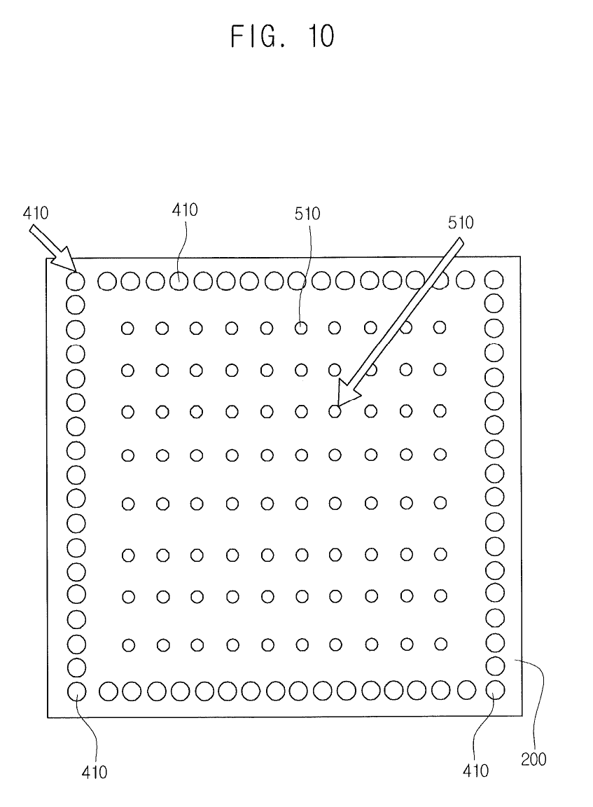

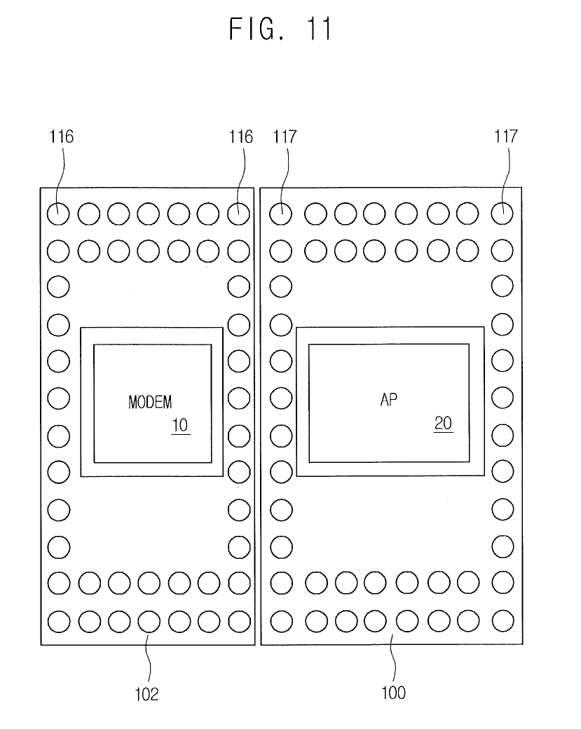

FIG. 8 is a diagram illustrating the structure of a multi-chip package according to another embodiment of the invention, and FIG. 9 is a detailed cross-sectional view of FIG. 8. FIG. 10 is a plan view illustrating a lower surface of a second circuit board shown in FIG. 9, and FIG. 11 is a plan view illustrating a lower surface of the first circuit board shown in FIG. 9.

Referring to FIG. 8, a multi-chip package according to a second embodiment of the invention includes a first package 150 and a second package 250.

The first package 150 includes first and second circuit boards 100 and 102 shown in FIG. 9. Predetermined circuit patterns are formed on the lower surfaces of the first and second circuit boards 102 and 100 on which the processor chips 10 and 20 will be respectively mounted. An upper pad layer is formed on the upper surface of each of the first and second circuit boards 102 and 100.

The second package 250 includes a third circuit board 200 shown in FIG. 9. A plurality of memory chips 40, 30, and 50 is formed on the upper surface of the third circuit board 200 having a predetermined circuit pattern provided thereon and is then molded in the same shape as that shown in FIG. 9. A lower pad layer that is electrically connected to the upper pad layers of the first and second circuit boards 102 and 100 is formed on the lower surface of the third circuit board 200. Routing lines L100 for electrical connection between the processor chips 10 and 20 is provided on the third circuit board 200. That is, the structure shown in FIG. 9 is different from that shown in FIG. 4 in that the MODEM 10 and the AP 20 in the first package 150 are electrically connected to each other by the third circuit board 200 in the second package 250.

In FIG. 8, it is noted that the upper pad layers of the first and second circuit boards 102 and 100 and the lower pad layer of the third circuit board 200 forming a pad layer 400 are denoted by one reference numeral. As shown in the cross-sectional view of FIG. 9, the pad layer 400 may include land grid array pads 410 that connect the upper pad layers and the lower pad layer. As shown in FIG. 11, the processor chips 10 and 20 may be mounted to the lower surfaces of the first and second circuit boards 102 and 100 so as to be surrounded by contact pads 116, and 117, respectively. In FIG. 9, reference numerals 12 and 13 indicate an insulating molding portion. In FIG. 10, a plurality of grid array pads 410 is arranged in a rectangular shape. In FIG. 10, reference numeral 510 indicates test pads. The test pads may be removed, if necessary.

In the structure according to the second embodiment shown in FIGS. 8 to 11, the processor packages each including processor chips and the memory package including laminated memory chips are integrally connected to each other through the land grid array pads. As shown in FIG. 9, the processor chips are electrically connected to each other by the routing lines L100 formed on the third circuit board 200. The routing lines L100 may be formed as a printed circuit pattern inside or on the third circuit board 200.

In the POP structure according to the second embodiment, since the upper and lower packages are directly connected to each other by LGA contact, the height of the package can be reduced, and it is possible to reduce the size of the package. In addition, since the processor chips of the processor package are electrically connected to each other by the circuit board of the memory package, it is possible to independently treat the parts of the manufacturing companies. Moreover, in the above-mentioned structure, the PCB may be less likely to be curved.

As can be seen from the above, according to the embodiments of the invention, since the processor package and the memory package are directly connected to each other through the land grid array pads, the height and size of the package are reduced.

In the multi-processor system according to the above-described embodiments of the invention, the number of processors or memories may be increased or decreased. The processors of the multi-processor system may include a microprocessor, a CPU, a digital signal processor, a microcontroller, a reduced command set computer, a complex command set computer, and equivalents thereof. In addition, the next-generation memory, such as a PRAM, may be considered as the memory chip. However, the number of processors in the system is not particularly limited. In addition, the scope of the invention is not limited to a specific combination of the processors having the same structure or different structures.

While the embodiments of the invention have been shown and described with reference to the accompanying drawings, it will be understood by one of ordinary skill in the art that various changes in form and details may be made therein without departing from the spirit and scope of the embodiments as defined by the following claims. For example, the structure of the memory link architecture, the kind or number of memory chips, and an electrical connection method may be changed or modified in various ways without departing from the scope and spirit of the invention.

In the above-described embodiments of the invention, the processors are connected to each other by the circuit board of the memory package. However, the processors may be connected to each other by a separate board. In addition, the multi-chip package structure used for the mobile device has been described as an example, but the invention is not limited thereto. For example, the technical spirit of the invention may be applied to various kinds of electronic apparatuses.

In the drawings and specification, there have been disclosed embodiments of the invention and, although specific terms are employed, they are used in a generic and descriptive sense only and not for limitation, the inventive scope being set forth in the following claims.

What is claimed is:

1. A multi-chip package structure comprising:
a first package including
a first circuit board including a lower surface including a first circuit pattern thereon and an upper surface, opposite the lower surface, including an upper pad layer thereon, and
at least one processor chip mounted on the lower surface of the first circuit board, and
a second package, mounted on the first package, including
a second circuit board including an upper surface including a second circuit pattern thereon and a lower surface, opposite the upper surface, including a lower pad layer thereon electrically connected to the upper pad layer of the first circuit board, and
at least one memory chip laminated and molded on the upper surface of the second package.

2. The multi-chip package structure of claim 1, wherein the upper pad layer and the lower pad layer are connected to each other by respective land grid array pads.

3. The multi-chip package structure of claim 2, wherein the at least one processor chip is mounted on the lower surface of the first circuit board and is surrounded by contact pads on the lower surface of the first circuit board.

4. The multi-chip package structure of claim 3, wherein the at least one processor chip includes a MODEM chip and an application chip.

5. The multi-chip package structure of claim 4, wherein the at least one memory chip includes a OneNAND™, a OneDRAM™, and a multi-bank DRAM each having a laminated structure.

6. A multi-chip package structure comprising:
a first package including
a first circuit board having a lower surface including circuit patterns formed separately and an upper surface, opposite the lower surface, including an upper pad layer thereon and
processor chips mounted on the lower surface of the first circuit board to be connected to the circuit patterns, and
routing lines electrically connecting the processor chips; and a second package including
a second circuit board including an upper surface including a circuit pattern and a lower surface, opposite the upper surface, including a lower pad layer electrically connected to the upper pad layer of the first package, and
at least one memory chip laminated and molded on the upper surface of the second package.

7. The multi-chip package structure of claim 6, wherein the upper pad layer and the lower pad layer are connected to each other by land grid array contact.

8. The multi-chip package structure of claim 7, wherein the processor chips are mounted on the lower surface of the first circuit board such that each of the processor chips is surrounded by contact pads on the lower surface of the first circuit board.

9. The multi-chip package structure of claim 6, wherein the routing lines are in or on the second circuit board.

10. The multi-chip package structure of claim 9, wherein the at least one memory chip includes a NAND flash memory, a multi-port semiconductor memory, and a multi-bank DRAM each having a laminated structure.

11. A multi-chip package structure comprising:
a first package including a first circuit board including a lower surface having a circuit pattern thereon and an upper surface having an upper pad layer thereon, and at least one first processor chip mounted on the lower surface of the first circuit board;
a second package including a second circuit board including a lower surface having a circuit pattern thereon and an upper surface including an upper pad layer thereon, and at least one second processor chip mounted on the lower surface of the second circuit board; and
a third package including
a third circuit board including an upper surface including a circuit pattern and a lower surface including a lower pad layer electrically connected to the upper pad layers of the first and second packages,
at least one memory chip laminated and molded on the upper surface of the third circuit board, and
routing lines electrically connecting the at least one first processor chip and the at least one second processor chip.
